(19) United States
(12) Patent Application Publication
(10) Pub. No.: US 2010/0153688 A1
(43) Pub. Date: Jun. 17, 2010

(54) APPARATUS AND METHOD FOR DATA PROCESS

(75) Inventor: Satoshi CHIBA, Kanagawa (JP)

Correspondence Address: YOUNG & THOMPSON, 209 Madison Street, Suite 500, Alexandria, VA, 22314, US

(73) Assignee: NEC Electronics Corporation, Kanagawa (JP)

(21) Appl. No.: 12/636,218

(22) Filed: Dec. 11, 2009

(30) Foreign Application Priority Data
Dec. 15, 2008 (JP) 2008-318064

(51) Int. Cl. G06F 9/30; G06F 9/38

(52) U.S. Cl. 712/205; 712/241; 712/E09.016; 712/E09.045

(57) ABSTRACT

An exemplary aspect of the present invention is a data processing apparatus for processing a loop in a pipeline that includes an instruction memory and a fetch circuit that fetches an instruction stored in the instruction memory. The fetch circuit includes an instruction queue that stores an instruction to be output from the fetch circuit, an evacuation queue that stores an instruction fetched from the instruction memory, a selector that selects one of the instruction output from the instruction queue and the instruction output from the evacuation queue, and a loop queue that stores the instruction selected by the selector and outputs to the instruction queue.

### BACKGROUND

1. Field of the Invention

The present invention relates to an apparatus and a method for data process, and particularly to an apparatus and a method for information processes that process an instruction in a pipeline.

2. Description of Related Art

A pipeline processor that executes an instruction in a pipeline is known as one of various processors. A pipeline is divided into multiple phases (stages) such as fetch, decode, and execute of an instruction. Multiple pipelines are overlapped, so that before the process of one instruction ends, the process of the subsequent instruction is started. Then the multiple instructions can be processed at the same time, thus attempting to increase the speed. Pipeline process is to process a series of phases for each instruction from the fetch phase to the execution phase. In recent years, the method to respond to operations with high-speed clocks by increasing the number of pipeline phase is often used.

On the other hand, DSP (Digital Signal Processor) is known as a processor to process a product-sum operation or the like at a higher speed than general-purpose microprocessors, and to realize specialized functions in various usages. Generally, a DSP needs to execute continuous repetition processes (loop process) efficiently. If an input and fetched instruction is a loop instruction, such DSP controls to repeat the process from the first instruction to the last instruction in the loop, instead of processing the instructions in the order of input. The technique concerning such loop control is disclosed in Japanese Unexamined Patent Application Publication Nos. 2005-284814 and 2007-207145, for example.

In order to increase the speed of the above loop process, Japanese Unexamined Patent Application Publication No. 2005-284814 discloses a data processing apparatus provided with a high-speed loop circuit. This high-speed loop circuit is provided with a loop queue for storing an instruction group which composes a repeatedly executed loop process. That is, the high-speed loop circuit enables to repeat the loop process without fetching the instruction group from an instruction memory, thereby increasing the speed of the loop process.

Note that the invention of Japanese Unexamined Patent Application Publication No. 2007-207145 is disclosed by the present inventor. The invention discloses an interlock generation circuit that suspends a pipeline process of a loop's last instruction until a pipeline process of a loop instruction is completed. This enables to correctly perform an end-of-loop evaluation.

### SUMMARY

However, the present inventor has found a problem that in the high-speed loop process technique disclosed in Japanese Unexamined Patent Application Publication No. 2005-284814, a correct instruction may not be executed if the number of pipeline phase is increased. In order to avoid this problem, the correct instruction must be fetched again from an instruction memory, thus it is unable to increase the speed.

An exemplary aspect of the present invention is a data processing apparatus for processing a loop in a pipeline that includes an instruction memory and a fetch circuit that fetches an instruction stored in the instruction memory. The fetch circuit includes an instruction queue that stores an instruction to be output from the fetch circuit, an evacuation queue that stores an instruction fetched from the instruction memory, a selector that selects one of the instruction output from the instruction queue and the instruction output from the evacuation queue, and a loop queue that stores the instruction selected by the selector and outputs to the instruction queue.

Another exemplary aspect of the present invention is a method of data process that includes storing a first instruction to an instruction queue to be output, where the first instruction is fetched from an instruction memory, storing a second instruction to an evacuation queue, where the second instruction is fetched from the instruction memory, selecting one of the first instruction stored to the instruction queue and the second instruction stored to the evacuation queue and storing to a loop queue, and outputting the instruction selected and stored in the loop queue to the instruction queue.

The apparatus and the method for data process are provided with an evacuation queue in addition to a loop queue, thus a loop process can be executed correctly at a high-speed even when the number of pipeline phases is increased.

The present invention provides a data process apparatus that achieves to execute fast and correct loop processes even with increased number of pipeline phases.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a block diagram of a processor according to a first exemplary embodiment of the present invention;

FIGS. 2A and 2B illustrate a pipeline configuration and an example of a program according to the first exemplary embodiment of the present invention;

FIG. 3 illustrates an example of executing a loop instruction by the processor according to the first exemplary embodiment of the present invention;

FIG. 4 is a block diagram of the processor according to a related art;

FIG. 5 illustrates an example of executing a loop instruction by the processor according to the related art;

FIG. 6 is a block diagram of a processor according to a second exemplary embodiment of the present invention;

FIGS. 7A and 7B illustrate a pipeline configuration and an example of a program according to the second exemplary embodiment of the present invention; and

FIG. 8 illustrates an example of executing a loop instruction by the processor according to the second exemplary embodiment of the present invention.

### DETAILED DESCRIPTION OF THE EXEMPLARY EMBODIMENTS

Hereafter, specific exemplary embodiments incorporating the present invention are described in detail with reference to the drawings. However, the present invention is not necessarily limited to the following exemplary embodiments. For clarity of explanation, the following descriptions and drawings are simplified as appropriate.

### First Exemplary Embodiment

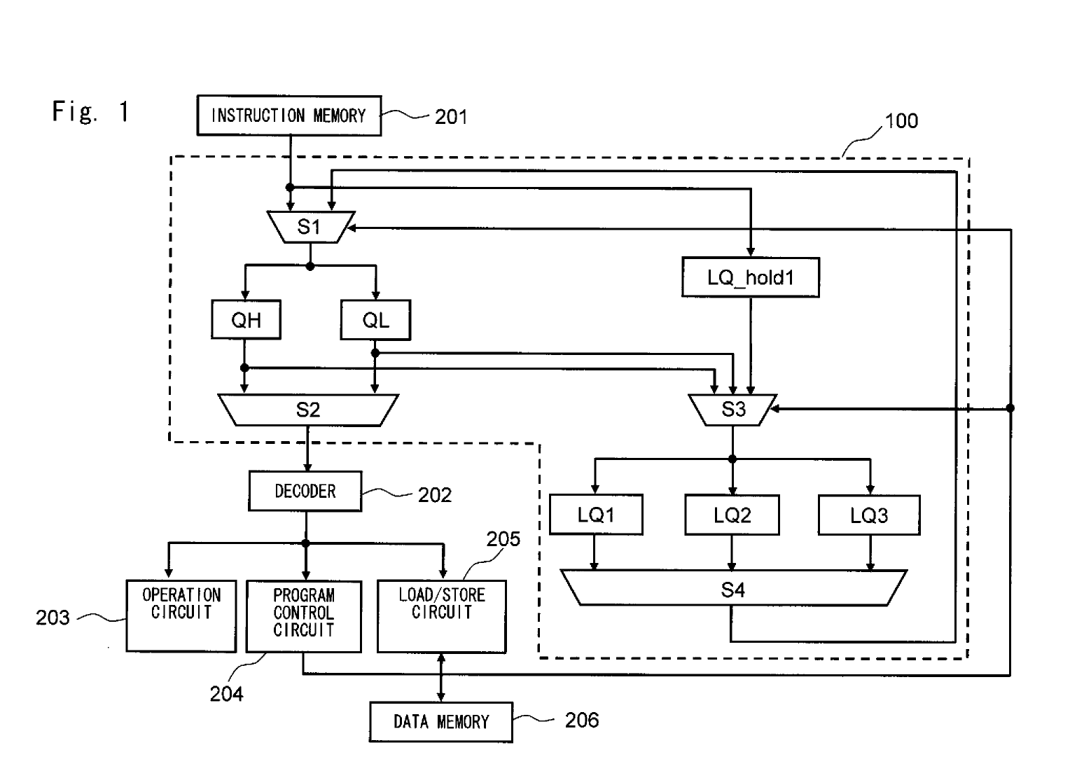

The configuration of a processor according to this exemplary embodiment is explained with reference to FIG. 1. This processor processes an instruction in a pipeline, and is a DSP that is capable of executing a loop instruction, for example. As illustrated in FIG. 1, the processor is provided with an instruction memory 201, a fetch circuit 100, a decoder 202, an operation circuit 203, a program control circuit 204, a load/store circuit 205, and a data memory 206.

An instruction to be executed is stored to the instruction memory 201 in advance. This instruction is a machine language code obtained by compiling a program created by a user.

The fetch circuit 100 is provided with four selectors S1 to S4, two instruction queues QH and QL, three loop queues LQ1 to LQ3, and one evacuation queue LQ_hold1. The fetch circuit 100 fetches (reads out) an instruction from the instruction memory 201. As described later in detail, the fetch circuit 100 executes a fetch phase (IF phase) process in a pipeline.

The selector S1 is connected to the instruction memory 201 and the selector S4, and selects an instruction output from either the instruction memory 201 or the selector S4. This selection is made by a control signal from the program control circuit 204. The instruction output from the selector Si is stored to the two instruction queues QH and QL in turn. If the instruction is a non-loop process, that is, a normal instruction, the selector 1 selects the instruction from the instruction memory 201 in principle. On the other hand, if the instruction is a loop process, the selector 1 in principle selects an inside loop instruction, which is stored to the loop queues LQ1 to LQ3 and output via the selector S4. This enables to execute the loop process at a high-speed.

An instruction to be output from the fetch circuit 100 is stored to the instruction queues QH and QL. The instructions stored to the instruction queues QH and QL are alternately output to the decoder 202 via the selector S2.

The instruction fetched from the instruction memory 201 is stored to the evacuation queue LQ_hold1. In this exemplary embodiment, an outside loop instruction is stored. However, it is not necessarily limited to an outside loop instruction. In general, if the stage number of IF phase is N and the number of instruction queue is Q, it is preferable that there are (N−1)−Q=(N−Q−1) number of the evacuation queues LQ_hold. In this exemplary embodiment, the stage number of IF phase N=4, and the number of instruction queues Q=2, thus there is one evacuation queue LQ_hold1.

The selector S3 selects one instruction from the three instructions stored respectively in the instruction queues QH and QL, and the evacuation queue LQ_hold1. This selection is made by a control signal from the program control circuit 204.

The loop queues LQ1 to LQ3 are registers that store predetermined number of instructions from a loop's first instruction. The instructions stored in the instruction queues QH and QL, and the evacuation queue LQ_hold1 are stored to the loop queues LQ1 to LQ3. In principle, inside loop instructions are stored to the loop queues LQ1 to LQ3. By skipping IF1 to IF3 in each inside loop instruction, the loop process can be repeated at a high-speed. For the stage number of the IF phase N, it is preferable to provide (N−1) number of loop queue LQ, in general. In this exemplary embodiment, there are four IF phases, thus three loop queues LQ1 to LQ3 are provided.

For instructions fetched by the fetch circuit 100, the decoder 202 assigns (dispatches) instructions, decodes, and calculates addresses, or the like. As described later in detail, the decoder 202 executes the decoding phases (DQ, DE, and AC phases) of a pipeline.

The operation circuit 203 and the load/store circuit 205 execute processes according to the decoding result of the decoder 202. As described later in detail, the operation circuit 203 and the load/store circuit 205 execute the execution phase (EX phase) of the pipeline. The operation circuit 203 performs various operations, such as addition. The data memory 206 stores operation results etc. The load/store circuit 205 accesses the data memory 206 to write/read data.

The program control circuit 204 controls the selectors Si and S3 in the fetch circuit 100 according to the decoded instruction, and controls to switch a loop process and a non-loop process. Further, the program control circuit 204 is provided with an interlock generation circuit, a loop counter, an end-of-loop evaluation circuit (not shown) etc. in a similar way as in Japanese Unexamined Patent Application Publication No. 2007-207145. That is, the program control circuit 204 controls an interlock, counts loop processes, and evaluates an end of the loop.

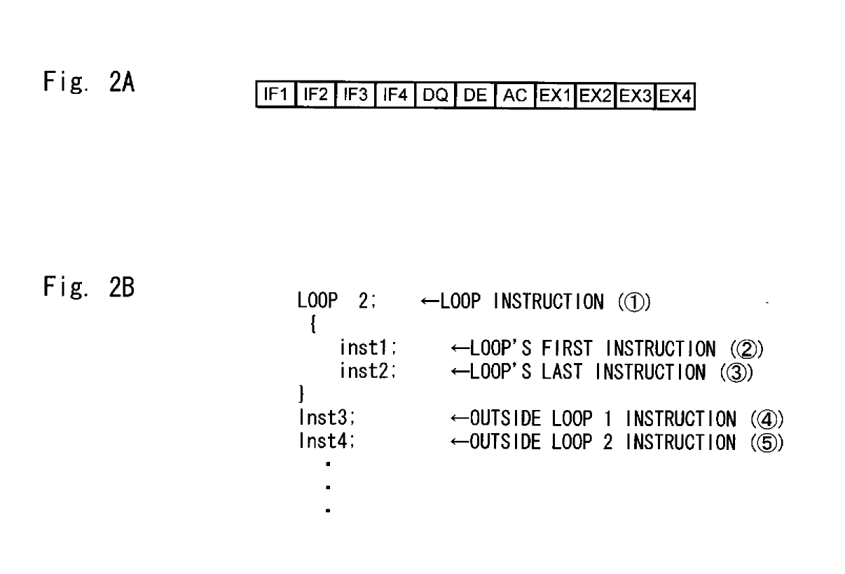

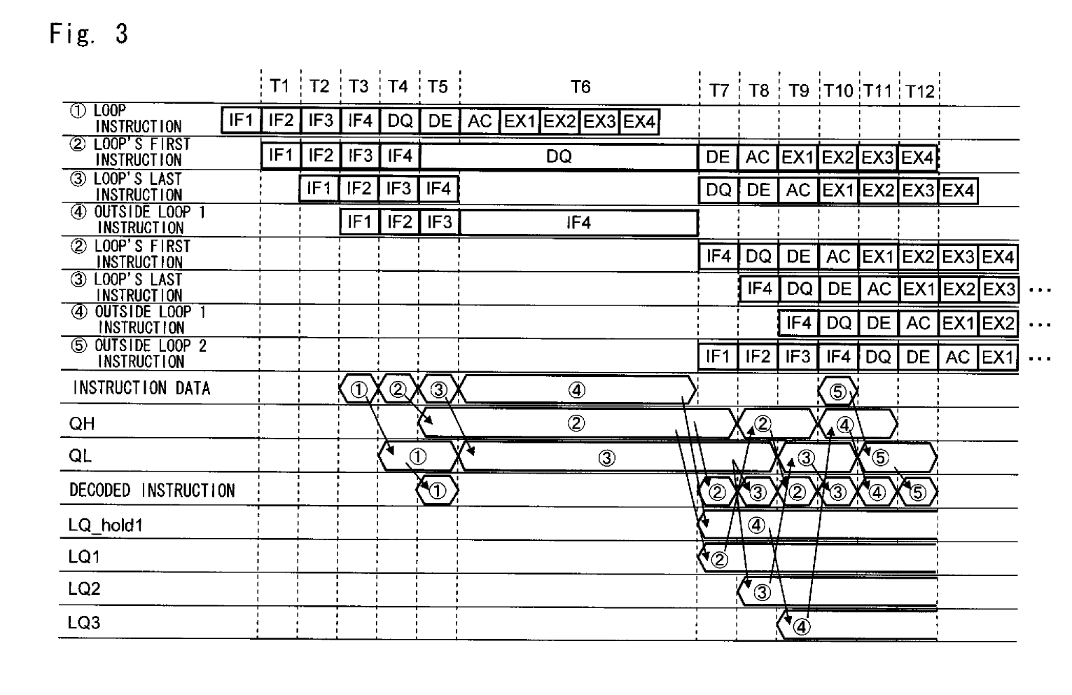

An example of pipeline processes for instructions by the processor according to this exemplary embodiment is described hereinafter. FIG. 3 illustrates a pipeline process when applying the pipeline of FIG. 2A, and executing the program of FIG. 2B by the processor.

The pipeline of FIG. 2A is divided into 11 phases of IF1 to IF4, DQ, DE, AC (Address Calculation), and EX1 to EX4 in order to respond to high-speed operations. An operation example of each phase is described hereinafter. In the IF1 to the IF4 phases, one instruction is fetched in 4 cycles. In the DQ phase, an instruction is assigned. In the DE phase, an instruction is decoded. In the AC phase, an address for accessing a data memory is calculated. Then, in EX1 to EX4 phases, an instruction is executed in one of the four cycles, for example in EX4. In principle, each phase is processed in one clock.

FIG. 2B illustrates an example of the program executed here. In this program, there is following description; “LOOP 2; (loop instruction)”, then an inside loop instruction composed of “inst(instruction) 1; (loop's first instruction)” and “inst2; loop's last instruction”, and then “inst3; (outside loop 1 instruction)” and “inst4; (outside loop 2 instruction)”.

The operand of the loop instruction indicates the loop count. In this example, the operand indicates that the inside loop instruction is repeated twice. Following the loop instruction, the instruction enclosed by curly brackets { } is the inside loop instruction executed repeatedly. The instruction described first in the inside loop instruction is referred to as a loop's first instruction, and the instruction described last in the inside loop instruction is referred to as a loop's last instruction. That is, the program repeatedly executes the loop's first instruction and the loop last instruction twice, and then executes the outside loop 1 instruction and subsequent instructions.

As illustrated in FIG. 3, each of the continuous instructions from a loop instruction (1) illustrated at the top line of FIG. 3 are fetched from the instruction memory 201 respectively by one clock as instruction data. As indicated in the “instruction data” of FIG. 3, each instruction is fetched as the instruction data in the IF4 phase, and stored to a predetermined place.

Specifically, at time T3, the loop instruction (1) is fetched as instruction data, and stored to the instruction queue QL.

Next, at time T4, a loop's first instruction (2) is fetched as instruction data, and stored to the instruction queue QH.

At time T5, when the loop instruction (1) is decoded in the DE phase of the loop instruction (1), the instruction queue QL becomes available. Then a loop's last instruction (3) is stored to the instruction queue QL at the end of time T5.

If the loop instruction (1) is decoded at time T5, an interlock is generated at time T6 from the AC phase to the EX4 phase of the loop instruction (1). Therefore, the pipeline process of the subsequent instructions is suspended in this period, and the DE phase of the loop's first instruction (2) will not be processed. That is, the DQ phase is extended. In connection with this, the IF phase of the outside loop 1 instruction (4) is extended.

When the execution of the loop instruction (1) is completed and the interlock ends, an end-of-loop is evaluated at the end of the DQ phase of the loop's first instruction (2), which is the end of time T6. Then a loopback is started, meaning that the process branches from the loop's last instruction to the loop's first instruction. At the same time, the loop's first instruction (2) stored to the instruction queue QH is copied to the loop queue LQ1, and the outside loop 1 instruction (4), which is waiting to be stored to the instruction queue in the IF4 phase, is copied to the evacuation queue LQ_hold1.

At time T7, the loop's first instruction (2) stored to the instruction queue QH is decoded, and the instruction queue QH becomes available once. However the loop's first instruction (2) is written back from the loop queue LQ1 to the instruction queue QH. The loop's last instruction (3) stored to the instruction queue QL is copied to the loop queue LQ2.

At time T8, the loop's last instruction (3) stored to the instruction queue QL is decoded, and the instruction queue QL becomes available once. However the loop's last instruction (3) is written back from the loop queue LQ2. Further, the outside loop 1 instruction (4) stored to the evacuation queue LQ_hold1 is copied to the loop queue LQ3.

At time T9, the loop's first instruction (2) stored to the instruction queue QH is decoded, and the instruction queue QH becomes available. Then the outside loop 1 instruction (4) is stored from the loop queue LQ3 to the instruction queue QH.

At time T10, the loop's last instruction (3) stored to the instruction queue QL is decoded, and the instruction queue QL becomes available. Then the outside loop 2 instruction (5) fetched from the instruction memory is stored to the instruction queue QL.

At time T11, the outside loop 1 instruction (4) stored to the instruction queue QH is decoded.

At time T12, the outside loop 2 instruction (5) stored to the instruction queue QL is decoded.

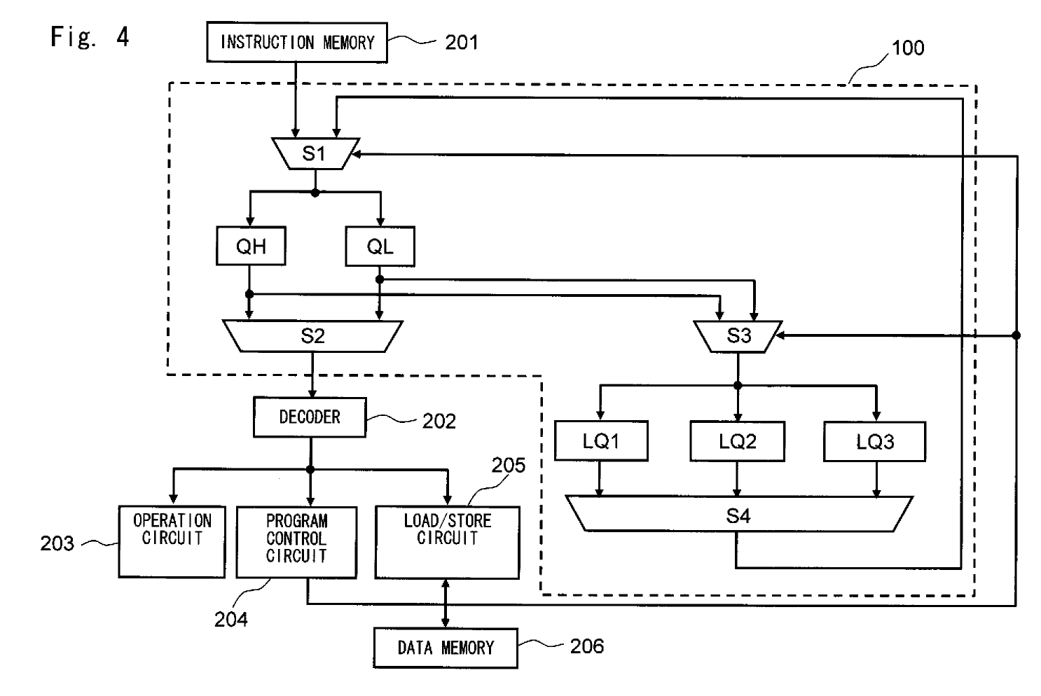

Next, a comparative example according to this exemplary embodiment is explained with reference to FIG. 4. FIG. 4 illustrates a processor according to the comparative example. The difference from the processor of FIG. 1 is that this processor is not provided with the evacuation queue LQ_hold1. Other configurations are same as the one in FIG. 1, thus the explanation is omitted.

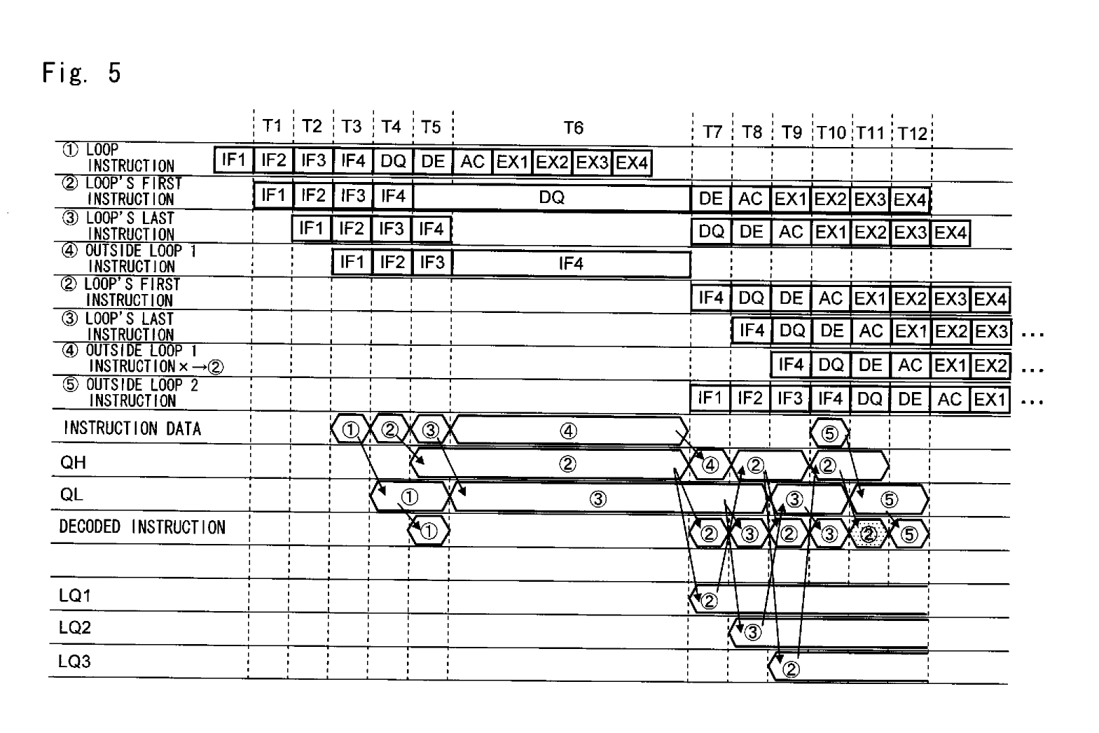

An example is explained hereinafter with reference to FIG. 5, in which each instruction is processed in a pipeline by the processor according to the comparative example. FIG. 5 illustrates a pipeline process when applying the pipeline of FIG. 2A and executing the program of FIG. 2B by the processor according to the comparative example.

The processes up to time T5 are same as in FIG. 3, thus the explanation is omitted. As in FIG. 3, when the execution of the loop instruction (1) is completed and an interlock ends at time T6, an end-of-loop evaluation is performed at the end of the DQ phase of the loop's first instruction (2), which is the end of the time T6. Then a loopback is started. At the same time, the loop's first instruction (2) stored to the instruction queue QH is copied to the loop queue LQ1. Then the outside loop 1 instruction (4), which is waiting to be stored to the instruction queue in the IF4 phase, is copied to QH.

At time T7, the loop's first instruction (2) stored to the instruction queue QH is decoded, and the loop's first instruction (2) is written back from the loop queue LQ1 to the instruction queue QH. This write back is necessary to execute the loop's first instruction (2) again. However at this time, the outside loop 1 instruction (4) stored to the instruction queue QH is rewritten by the loop's first instruction (2). Further, the loop's last instruction (3) stored to the instruction queue QL is copied to the loop queue LQ2.

At time T8, the loop's last instruction (3) stored to the instruction queue QL is decoded and the instruction queue QL becomes available once. However the loop's last instruction (3) is written back from the loop queue LQ2. Further, the loop's first instruction (2) stored to the instruction queue QH is copied to the loop queue LQ3.

At time T9, the loop's first instruction (2) stored to the instruction queue QH is decoded and the instruction queue QH becomes available. Then the loop's first instruction (2) is written back from the loop queue LQ3.

At time T10, the loop's last instruction (3) stored in instruction queue QL is decoded, the instruction queue QL becomes available, and the outside loop 2 instruction (5) fetched from the instruction memory is stored to the instruction queue QL.

At time T11, the loop's first instruction (2), not the intended outside loop 1 instruction (4), is decoded.

At time T12, the outside loop 2 instruction (5) is decoded.

As described above, in the comparative example, the outside loop 1 instruction (4) cannot be stored to the loop queue LQ3, thus the loop process is not correctly executed. On the other hand, if the outside loop 1 instruction (4) is fetched again from the instruction memory 201 after getting out of the loop, the loop process can be correctly executed. However in that case, the process returns to the IF1 phase and the speed is reduced. Such problem could occur if the number of instruction in the loop process is smaller than the number of the loop queue. In the case of the comparative example, the number of the instructions in the loop process is 2, and the number of the loop queues is 3.

On the other hand, the processor according to the first exemplary embodiment is provided with the evacuation queue LQ_hold1 to store the outside loop 1 instruction (4). Then, the outside loop 1 instruction (4) can be copied from the evacuation queue LQ_hold1 to the loop queue LQ3 at a predetermined timing. Therefore, the loop process can be performed correctly at a high-speed.

### Second Exemplary Embodiment

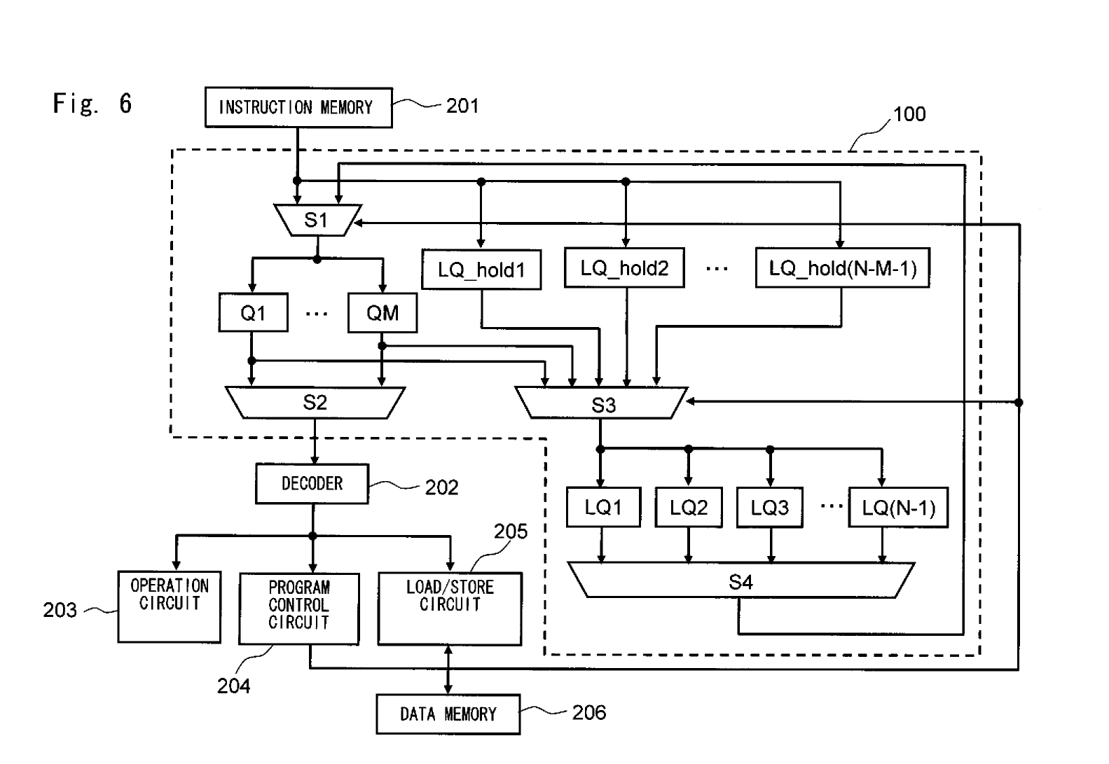

A processor according to the second exemplary embodiment of the present invention is explained with reference to FIG. 6. The differences from the processor of FIG. 1 are the number of the evacuation queues LQ_hold and the number of the loop queues LQ. Other configurations are the same as that of FIG. 1, thus the explanation is omitted.

This exemplary embodiment generalizes the preferable number of the evacuation queues LQ_hold and the preferable number of loop queues LQ. To be more specific, the number of pipeline phases required for fetching an instruction, or the stage number of the IF phase, is N. In order to realize a loopback with no overhead, the processor is provided with (N−1) number of loop queues LQ1, LQ2, LQ3, . . . and LQ(N−1). Further, (N−Q−1) number of evacuation queues LQ_hold1, LQ_hold2, . . . , and LQ_hold (N−Q−1) are provided since the processor is provided with Q number of instruction queues Q1, Q2, Q3, . . . and QQ.

However, it is necessary to satisfy the relationship of N<=Q+M+1. M is the minimum execution packet number in the loop process. This formula is explained hereinafter.

(1) As indicated above, (N−1) number of loop queues are required.

(2) An end-of-loop is evaluated by the loop's first instruction and assume that a loopback is started. At the time of an end-of-loop evaluation, Q number of instructions from the loop's first instruction are held to the instruction queue. Further, the (Q+1)th instruction from the loop's first instruction, which is waiting to be stored to the instruction queue, exists before the instruction queue. That is, there is (Q+1) number of data storable to the loop queue.

(3) If there are more than (Q+1) number of loop queues, data more than (Q+1) must be retrieved from the data to be stored to the instruction queue while executing the loop process.

(4) As the minimum execution packet number is M, (M−1) number of packets are executed after the end-of-loop evaluation and before the loopback.

(5) Thus, {(N−1)−(Q+1)} number of instruction data must be retrieved by (M−1) packets or less.

Accordingly, (N−1)−(Q+1)<=M−1

Therefore, it is necessary to satisfy the relationship of N<=Q+M+1.

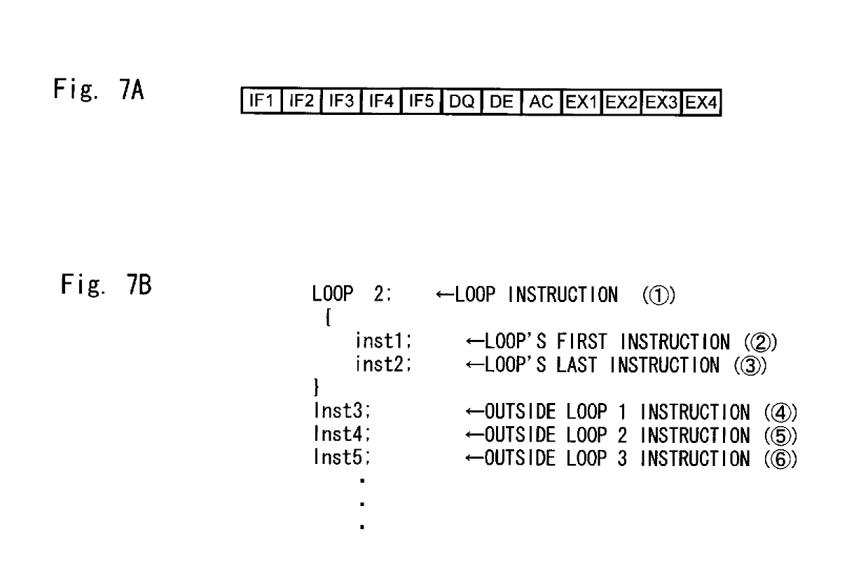

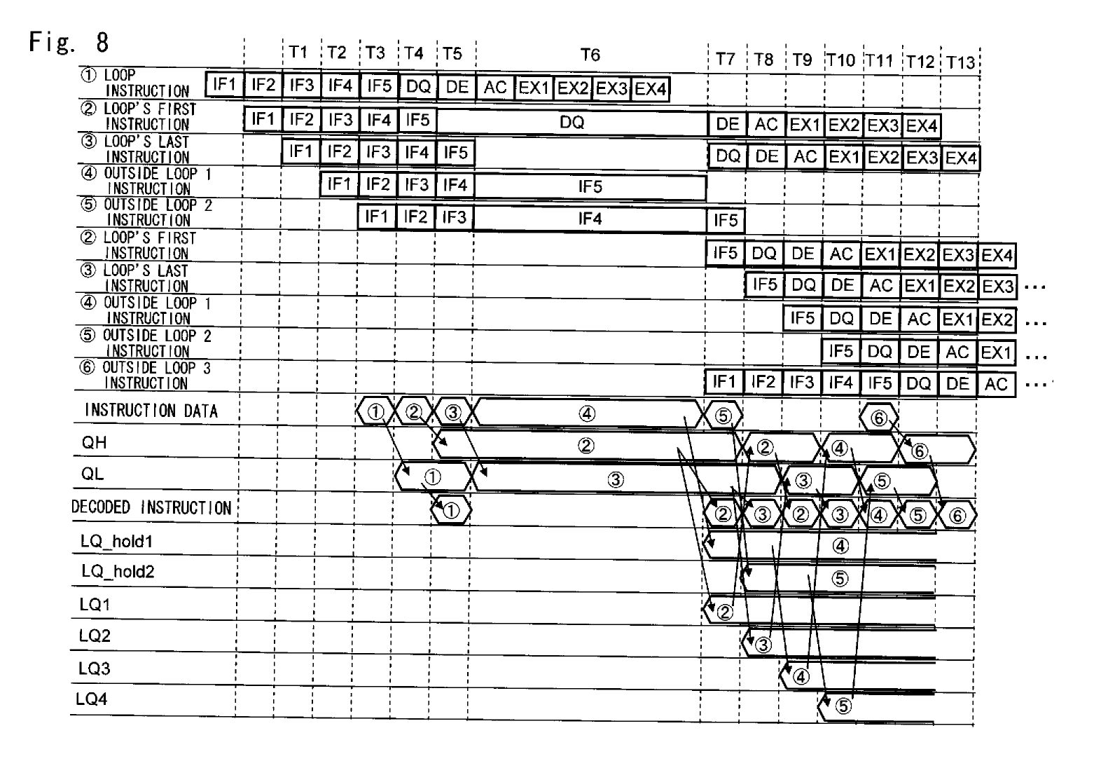

A specific example is explained hereinafter, in which each instruction is processed by pipelining in the processor according to this exemplary embodiment. FIG. 8 illustrates a pipeline process when applying the pipeline of FIG. 7A and executing the program of FIG. 7B by the processor.

The pipeline of FIG. 7A is divided into 12 phases of IF1 to IF5, DQ, DE, AC (Address Calculation), and EX1 to EX4 in order to respond to high-speed operations. Accordingly, the stage number of the IF phase N=5. The other configurations are same as FIG. 2A. Further, as with the first exemplary embodiment, the number of instruction queues Q=2. FIG. 7B is an example of the program executed here. The outside loop 3 instruction is added to the end of FIG. 2B.

As indicated in the “instruction data” in FIG. 8, each instruction is fetched as instruction data in the IF5 phase and stored to the predetermined place.

To be more specific, at time T3, the loop instruction (1) is fetched as instruction data and stored to the instruction queue QL.

Next, at time T4, the loop's first instruction (2) is stored to the instruction queue QH.

At time T5, when the loop instruction (1) is decoded in the DE phase of the loop instruction (1), the instruction queue QL becomes available. Then the loop's last instruction (3) is stored to the instruction queue QL at the end of time T5.

If the loop instruction (1) is decoded at time T5, an interlock is generated from the AC phase to the EX4 phase of the loop instruction (1) at time T6. Therefore, the pipeline process of the subsequent instructions is suspended in this period and the DE phase of the loop's first instruction (2) will not be processed. That is, the DQ phase is extended. In connection with this, the IF5 phase of the outside loop 1 instruction (4) and the IF4 phase of the outside loop 2 instruction (5) are extended.

When the execution of the loop instruction (1) is completed and an interlock ends, an end-of-loop evaluation is performed at the end of the DQ phase of the loop's first instruction (2), which is the end of the time T6. Then a loopback is started. At the same time, the loop's first instruction (2) stored to the instruction queue QH is copied to the loop queue LQ1. Then the outside loop 1 instruction (4), which is waiting to be stored to the instruction queue in the IF5 phase, is copied to the evacuation queue LQ_hold1.

At time T7, the loop's first instruction (2) stored to the instruction queue QH is decoded and the instruction queue QH becomes available once. However the loop's first instruction (2) is written back from the loop queue LQ1. Further, the loop's last instruction (3) stored to the instruction queue QL is copied to the loop queue LQ2. Further, the outside loop 2 instruction (5) fetched from the instruction memory is stored to the evacuation queue LQ_hold2.

At time T8, the loop's last instruction (3) stored to the instruction queue QL is decoded and the instruction queue QL becomes available once. However the loop's last instruction (3) is written back from the loop queue LQ2. Further, the outside loop 1 instruction (4) stored to the evacuation queue LQ_hold1 is copied to the loop queue LQ3.

At time T9, the loop's first instruction (2) stored to the instruction queue QH is decoded and the instruction queue QH becomes available. Then the outside loop 1 instruction (4) is stored from the loop queue LQ3 to the instruction queue QH. The outside loop 2 instruction (5) stored to the evacuation queue LQ_hold2 is copied to the loop queue LQ4.

At time T10, the loop's last instruction (3) stored to the instruction queue QL is decoded and the instruction queue QL becomes available. Then the outside loop 2 instruction (5) is stored from the loop queue LQ4 to the instruction queue QL.

At time T11, the outside loop 1 instruction (4) stored to the instruction queue QH is decoded and the instruction queue QH becomes available. Then the outside loop 3 instruction (6) fetched from the instruction memory is stored to the instruction queue QH.

At time T12, the outside loop 2 instruction (5) stored to the instruction queue QL is decoded.

At time T13, the outside loop 3 instruction (6) stored to the instruction queue QH is decoded.

As described so far, the processor according to this exemplary embodiment is provided with the evacuation queue LQ_hold and is able to store an outside loop instruction. Then, the processor can copy the outside loop instruction to the loop queue LQ from the evacuation queue LQ_hold at a predetermined timing. Therefore, a loop process can be performed correctly at a high-speed.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. A data processing apparatus for processing a loop in a pipeline comprising:
an instruction memory; and
a fetch circuit that fetches an instruction stored in the instruction memory,
wherein the fetch circuit comprises:
an instruction queue that stores an instruction to be output from the fetch circuit;
an evacuation queue that stores an instruction fetched from the instruction memory;
a selector that selects one of the instruction output from the instruction queue and the instruction output from the evacuation queue; and
a loop queue that stores the instruction selected by the selector and outputs to the instruction queue.

2. The data processing apparatus according to claim 1, wherein if a number of fetch phase in the pipeline process of the fetch circuit is N, a number of the loop queue is (N−1).

3. The data processing apparatus according to claim 2, wherein if a number of the instruction queue is Q, a number of the evacuation queue is (N−Q−1).

4. The data processing apparatus according to claim 3, wherein if a minimum execution packet number in a loop process is M, N<=Q+M+1.

5. The data processing apparatus according to claim 1, wherein the minimum execution packet number in the loop process is smaller than the number of the loop queue.

6. The data processing apparatus according to claim 5, wherein the minimum execution packet number in the loop process is 2.

7. A method of data process comprising:
storing a first instruction to an instruction queue to be output, the first instruction being fetched from an instruction memory;
storing a second instruction to an evacuation queue, the second instruction being fetched from the instruction memory;
selecting one of the first instruction stored to the instruction queue and the second instruction stored to the evacuation queue and storing to a loop queue; and
outputting the instruction selected and stored in the loop queue to the instruction queue.
